(19) United States
(12) Patent Application Publication
(10) Pub. No.: US 2009/0273923 A1
(43) Pub. Date: Nov. 5, 2009

(54) SANITARY FITTING COMPRISING AT LEAST ONE ILLUMINATING DEVICE

(75) Inventor: Gunter Veigel, Leonberg (DE)

Correspondence Address: FACTOR & LAKE, LTD, 1327 W. WASHINGTON BLVD., SUITE 5G/H, CHICAGO, IL, 60607, US

(73) Assignee: HANSA METALLWERKE AG, Stuttgart (DE)

(21) Appl. No.: 12/305,659

(22) PCT Filed: May 31, 2007
(86) PCT No.: PCT/EP07/04798

§ 371 Date: May 13, 2009

(30) Foreign Application Priority Data
Jun. 22, 2006 (DE) 10 2006 028 587.5

(51) Int. Cl. F21S 8/00; F21V 33/00

(52) U.S. Cl. 362/235

(57) ABSTRACT

The invention relates to a sanitary fitting provided with at least one illuminating device comprising at least two illuminants, especially RGB illuminants, having different irradiation colours for generating light with a colour obtained by mixing different irradiation colours, and a diffuser for the light. At least one beam splitter for splitting the light beams into a main partial beam and a reflected partial beam is arranged between each illuminant and the diffuser. A deviation means for deviating the corresponding reflected partial beam is respectively applied such that the reflected partial beam and the main partial beam hit in different regions on the diffuser.

The invention relates to a sanitary fitting comprising at least one illuminating device, which has at least two lamps, in particular RGB lamps, having different radiation colours for generating light with a colour additively mixed from the different radiation colours, and comprising a diffuser for the light.

In the case of such known sanitary fittings, the function of the lamps is to illuminate an emerging water jet. Such lamps may, however, also have the purpose of signalling actuations of the adjusting elements or characterising operating parameters, such as the water temperature and/or the water flow rate. They may, however, also be provided merely to create a visually attractive design.

In the case of sanitary fittings known on the market, RGB lamps are employed to generate light of a colour symbolising the prevailing water temperature. When the water temperature rises, for example, the colour of the light changes from blue to red.

Known RGB lamps have separate lamp elements for the primary colours red, green and blue, the light of which radiates onto a scattering covering glass acting as a diffuser. From the viewing side, the covering glass appears in the desired mixed colour. To change the mixed colour, the lamp elements are appropriately controlled. However, the spatial distribution of the lamp elements produces an inhomogeneous colour representation, in particular colour streaks, on the viewing side of the covering glass.

The object of the present invention is to design a sanitary fitting of the type mentioned at the outset in which as far as possible monochrome light with a homogeneous colour distribution is visible on the viewing side of the diffuser.

This object is achieved according to the invention in that at least one beam splitter for splitting the light beams into a main partial beam and a reflected partial beam is arranged between each lamp and the diffuser, and a deflecting means for deflecting the corresponding reflected partial beam is in each case provided in such a way that the reflected partial beam and the main partial beam impinge on the diffuser in different regions.

According to the invention, therefore, each lamp is assigned a beam splitter which splits the light into two partial beams and supplies it to two separate regions of the diffuser. Each lamp thus illuminates a greater area overall. A considerably better additive mixing of the colours emitted by the different lamps therefore takes place, so that the mixed colour also appears significantly more uniform, preferably almost monochrome.

In a particularly advantageous embodiment, the beam splitter can have a partially reflective first, in particular plane, surface, which is inclined by in particular 45° with respect to the main radiating direction of the light radiating in, and the deflecting means can have in the beam path of the reflected partial beam an at least partially reflective second, in particular plane, surface which faces the first surface, is spaced from it and has substantially the same inclination as it. In this way, part of the light can be simply separated from the incoming light beam and led onto the diffuser in a manner spaced from the main is partial beam. With an inclination of the first surface of 45°, the beam splitter has a reflectance of approximately 0.5, given an appropriate refractive index, so that the light intensities of the main partial beam and of the reflected partial beam are approximately equal. In this way, a uniform illumination of the diffuser at the two impingement regions is achieved.

Specifically, in each case an, in particular plane, surface region, inclined with respect to the main radiating direction, of a single lens body can form the beam splitter and the deflecting means respectively as well, resulting in a compact optical system which can be simply fitted with the lamp(s).

Expediently, the lens body can be made from plastic, in particular from polycarbonate. Lens bodies made from plastic can be simply produced.

In a further particularly advantageous embodiment, the centre points of three beam splitters for three lamps can be arranged at the corners of an, in particular, equilateral first triangle and the centre points of three deflecting means corresponding to the beam splitters can be arranged in each case between two beam splitters, in particular at the corners of a similar second triangle rotated by 180° with respect to the first triangle about the latter's axis of the centre of gravity. With three lamps, the primary colours red, green and blue can be emitted to realise the RGB colour model. The arrangement at the corners of an equilateral triangle enables uniform overlapping of all three colours. The arrangement of the deflecting means rotated by 180° ensures that in each case the same colours impinge on opposite regions of the diffuser, with the result that the mixing of the colour components is markedly improved.

Preferably, the lamps can be a red, a green and a blue LED. LEDs can be simply produced, are robust, small and have a high efficiency.

An exemplary embodiment of the invention is explained in more detail below with the aid of the drawing, in which

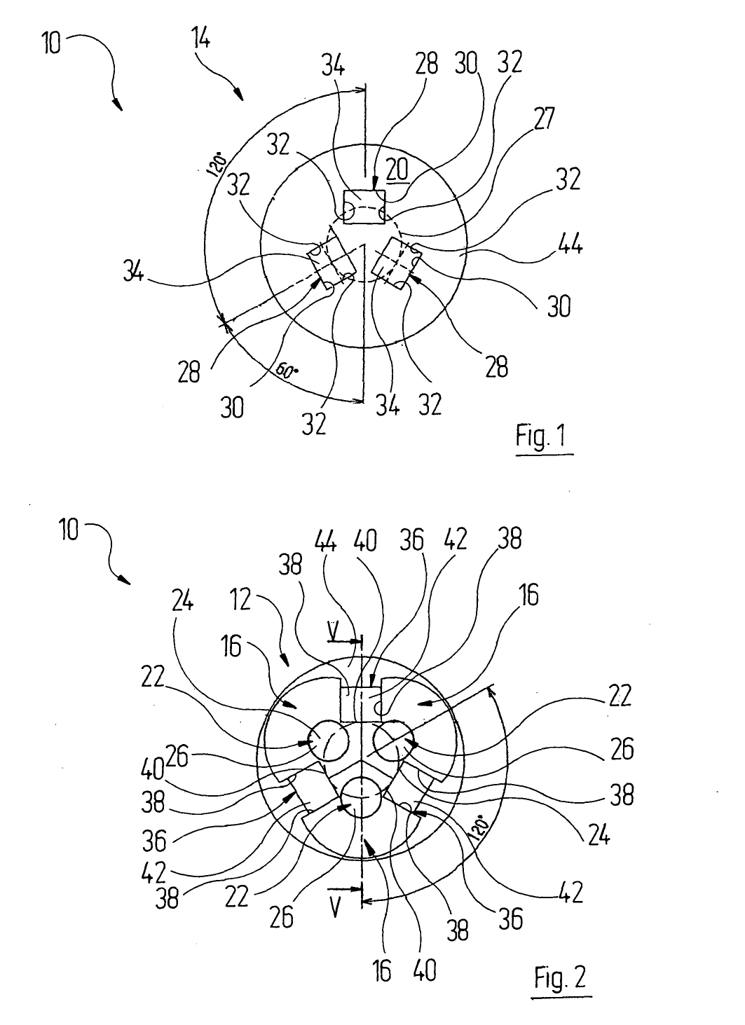

FIG. 1 shows schematically the bottom view of a lens body of an illuminating device having three LEDs for a sanitary fitting;

FIG. 2 shows schematically the lens body from FIG. 1 in top view;

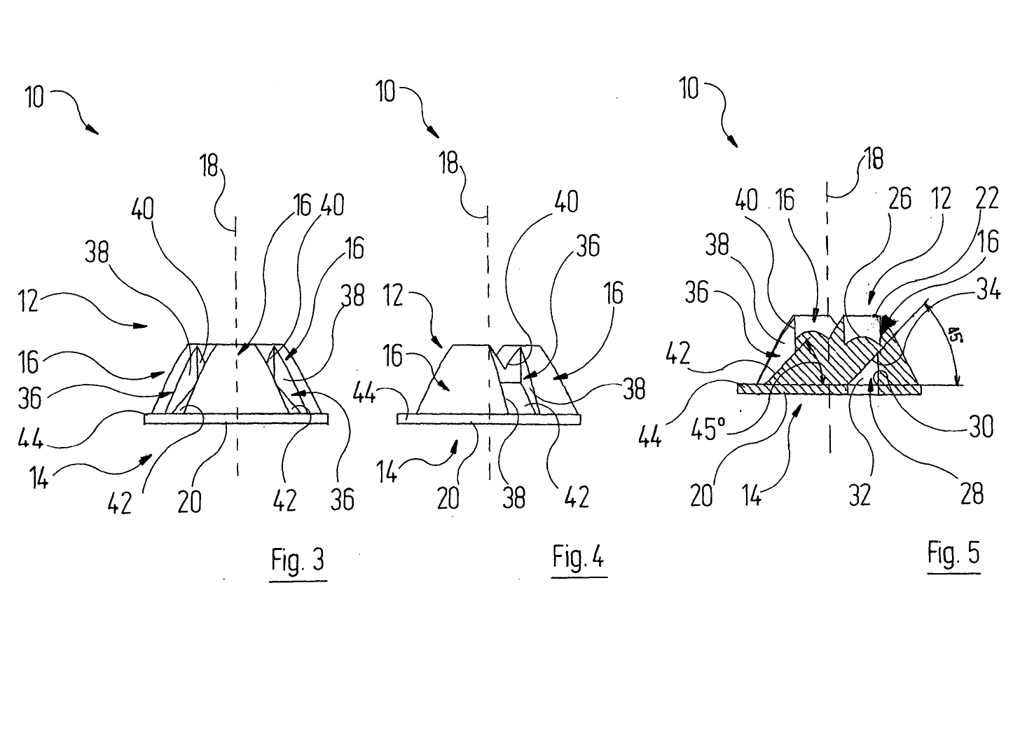

FIG. 3 shows schematically the lens body from FIGS. 1 and 2 in a side view;

FIG. 4 shows schematically the lens body from FIGS. 1 and 2 in a different side view;

FIG. 5 shows schematically the lens body from FIG. 2 in axial section along the section line V-V therein;

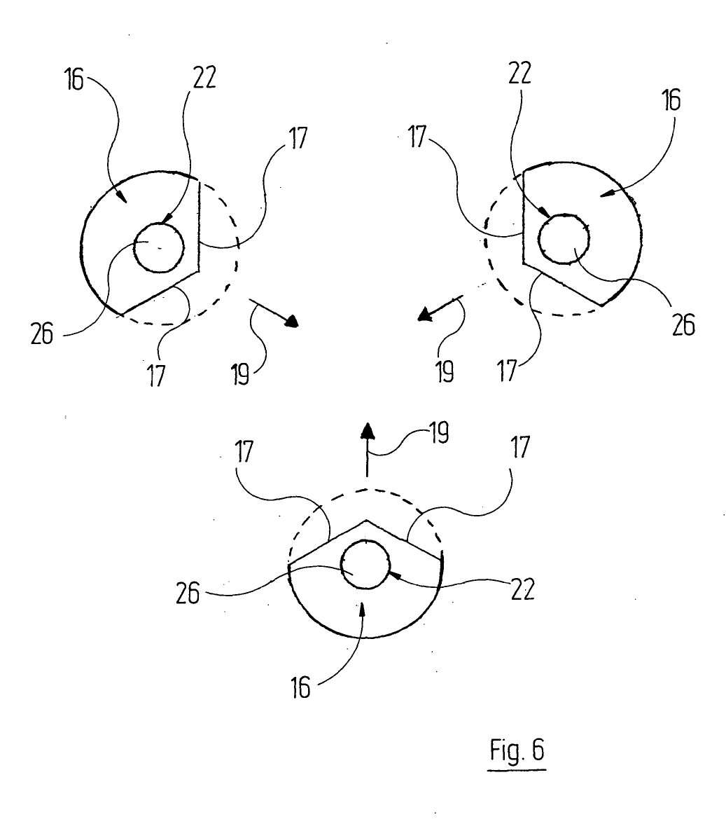

FIG. 6 shows schematically an auxiliary construction for making clear the outer contours of the lens body from FIGS. 1 to 5.

FIG. 1 illustrates a lens body, provided as a whole with the reference numeral 10, of an illuminating device, otherwise not shown, for a sanitary fitting.

By means of the lens body 10, the light emitted by in each case one red, green and blue LED (not shown) introduced from a diode-receiving side 12, at the top in FIGS. 3 to 5, is distributed in such a way that it can be additively mixed in accordance with the RGB colour model by means of a light-transmitting covering disc (not shown) which scatters the light. The covering disc is arranged on the light exit side 14 of the lens body 10, at the bottom in FIGS. 3 to 5.

The lens body 10 is produced in one piece from polycarbonate of optical quality and is preferably UV-stabilised; at least its surfaces on or through which the light of the LEDs shines are optically ground.

The lens body 10 can be thought of as being put together in the following way, as is made clear by an auxiliary construction shown in FIG. 6, which shows the lens body 10 in top view broken down in its imaginary individual components:

Take three identical right truncated cones which form in each case one receiving region 16 for in each case one of the LEDs. The surface lines of the circular truncated cones are, when seen from outside, curved slightly convexly, preferably parabolically, in particular in the manner of a Fraen lens, and the lateral surfaces are optically ground. The lateral surfaces of the truncated cones can thus act as reflectors for light coming from the interior of the truncated cones. Then, cut each circular truncated cone with two planes which each run parallel to the centre axes (not shown) of the circular truncated cones and intersect one another at an angle of 120°. The resulting cut surfaces 17, which—since they are imaginary—are only shown in the auxiliary construction in FIG. 6, extend over approximately two thirds of the height of the circular truncated cones. Next, place the three cut circular truncated cones against one another by their cut surfaces 17 in the direction of the arrows 19 in such a way that their centre axes are arranged parallel to one another at the corners of a first imaginary equilateral triangle, the centre of gravity of which lies on the axis 18 through the centre of gravity of the lens body 10. The lens body 10 put together in this way is shown in FIGS. 3 to 5. The axis 18 through the centre of gravity is indicated by broken lines in FIGS. 3 to 5. It is perpendicular to a base 20 of the lens body 10, which for its part is situated on the light exit side 14. Where the cut surfaces 17 lie against one another, the circular truncated cones merge integrally into one another. Thereupon, make an indentation 36, shown in FIGS. 3 to 5, in each case between two circular truncated cones at the lateral surfaces of the lens body 10, the shape of which indentation will be described in more detail further below.

Integrally formed on the bases of the circular truncated cones is an annular flange 44 which terminates the light-exit-side base 20 of the lens body 10 in the circumferential direction. The base 20 projects beyond the outermost edges of the bases of the circular truncated cones. The base 20 is optically ground.

Leading from the diode-receiving side 12 into each receiving region 16 is a circular-cylindrical, slightly conical receiving opening 22, visible in FIGS. 2 and 5, for the corresponding LED.

The longitudinal axes of the receiving openings 22 run almost coaxially with the respective centre axes of the circular truncated cones, forming the receiving regions 16, through the corners of an imaginary, second equilateral triangle, which is oriented parallel to the base 20 of the lens body 10. The centre of gravity of the second equilateral triangle lies on the axis 18 of the centre of gravity of the lens body 10. Its corners lie on a circle 24 coaxial with the axis 18 of the centre of gravity, which circle is indicated by a broken line in FIG. 2. The radius of the circle 24 is approximately half the size of the radii of the bases of the circular truncated cones forming the receiving regions 16. The median lines of the second triangle run parallel to those of the first equilateral triangle, through the corners of which the centre axes of the circular truncated cones of the receiving regions 16 lead.

The bottoms 26, visible in FIGS. 2 and 5, of the receiving openings 22 are situated somewhat above half the height of the lens body 10. The receiving openings 22 taper towards their bottoms 26; their inner lateral surfaces are inclined by approximately 1° with respect to their longitudinal axes. The diameters of the receiving openings 22 at their narrowest points at the level of their bottoms 26 are approximately half the size of the radii of the bases of the circular truncated cones of the receiving regions 16.

The surfaces, facing the diode-receiving side 12, of the bottoms 26 are, when seen from there, convexly curved and serve in each case as a condenser for the light emitted by the corresponding LED. The surfaces are optically ground.

The red, the blue and the green LED, respectively, are arranged, not illustrated in the figures, in the is receiving openings 22 in such a way that they radiate substantially in the direction of the light exit side 14 (main radiating direction).

The receiving openings 22 are easily accessible from outside the lens body 10. In this way, the lens body 10 can be moulded in one piece, and the receiving openings 22 can made in each case by means of a removable core.

Situated in the extension of each receiving opening 22 on the light exit side 14 of each receiving region 16 at a distance below the bottom 26 of the receiving opening is a wedge-shaped beam splitter space 28, visible in FIGS. 1 and 5, which is open towards the light exit side 14. The beam splitter spaces 28 have rectangular bases, which is visible in the bottom view of FIG. 1. Each beam splitter space 28 is delimited by a tangential wall 30 and two radial walls 32, which all run perpendicularly to the base 20 of the lens body 10, and also by a beam splitter surface 34. The tangential wall 30 furthermore runs in a plane perpendicular to the median line of the first and of the second imaginary triangle respectively and delimits the side of the beam splitter space 28 facing away from the axis 18 of the centre of gravity of the lens body 10. The extent of the beam splitter space 28 in the direction of the median line of the imaginary triangles on its open side is somewhat smaller than the is diameter of the receiving openings 22 at their narrowest points in the region of the bottoms 26.

The radial walls 32 of a beam splitter space 28 run parallel to one another and perpendicular to the tangential wall 30. Their spacing from one another corresponds approximately to the smallest diameter of the receiving openings 22.

On the side of the diode receptacle, the beam splitter spaces 28 are in each case, as already mentioned, delimited by the beam splitter surface 34, which is arranged at a distance, in FIGS. 3 to 5, below the bottoms 26 of the receiving openings 22. The beam splitter surfaces 34 are inclined by 45° with respect to the bases 20 of the lens body 10, in such a way that light coming from the receiving openings 22 is partially reflected towards the axis 18 of the centre of gravity. The centre points of the beam splitter surfaces 34 lie on a circle 27 around the axis 18 of the centre of gravity which has the same diameter as the circle 24; this is visible in FIG. 1. As a whole, the centre points of the beam splitter surfaces 34 are situated at the corners of an equilateral triangle which is congruent, seen in the direction of the axis 18 of the centre of gravity, with the second triangle, through the corners of which run the centre axes of the receiving openings 22 lying thereabove.

The beam splitter spaces 28 serve essentially to realise the beam splitter surfaces 34. They can easily be made in a lens body blank by means of a core during moulding, in order to obtain the beam splitter surfaces 34 in the one-piece lens body 10. The beam splitter surfaces 34 are optically ground.

Furthermore, the lateral surfaces of the lens body 10 in each case have the indentations 36, already mentioned, between two receiving regions 16; the indentations 36 are visible in FIGS. 2 to 5. The indentations 36 are situated in each case opposite one of the receiving openings 22. They are delimited at their flanks by two parallel, plane flank surfaces 38. The flank surfaces 38 run on both sides in each case at the same distance from and parallel to the plane which is defined by the axis 18 of the centre of gravity of the lens body 10 and the centre axis of the opposite receiving opening 22.

On the side facing the axis 18 of the centre of gravity of the lens body 10, each indentation 36 is delimited by a plane rear-side surface 40 which extends between the flank surfaces 38 tangentially to the circle 24 from the diode-receiving side 12 of the lens body 10 up to the level of that edge of the opposite beam splitter surface 34 which faces the diode-receiving side 12. The rear-side surfaces 40 run in planes perpendicular to the base 20 of the lens body 10 and perpendicular to the flank surfaces 38.

On the side facing the light exit side 14, each is indentation 36 is delimited by an optically ground mirror surface 42. These surfaces are inclined in each case by 45° with respect to the base 20 in such a way that they deflect light, coming from the partially reflective in each case opposite beam splitter surface 34, substantially towards the light exit side 14. The mirror surfaces 42 thus act as deflecting devices for the light.

The centre points of the three mirror surfaces 42 of the indentations 36 corresponding to the beam splitter surfaces 34 are arranged at the corners of a further equilateral triangle similar to the second triangle and rotated by 180° with respect to it about the axis 18 of the centre of gravity.

The indentations 36 serve primarily to realise the mirror surfaces 42. They are produced, for example, on moulding the lens body 10 in an appropriate mould.

The lens body 10 works as follows:

The light emitted by the LEDs enters the lens body 10 via the convex surfaces of the bottoms 26 of the respective receiving opening 22 and impinges on the corresponding beam splitter surfaces 34 there.

The beam splitter surfaces 34 split the light in each case approximately with half the intensity into a main partial beam and a reflected partial beam.

The main partial beams radiate through the beam splitter surfaces 34 in accordance with the general laws of refraction in the direction of the light exit side 14, where they exit from the lens body 10 and impinge on the covering disc. The reflected partial beams are deflected in the direction of the axis 18 of the centre of gravity of the lens body 10.

The mirror surfaces 42 deflect the reflected partial beams, coming from the opposite beam splitter surfaces 34, in each case towards the base 20 of the lens body 10, where they exit from the base 20 of the lens body 10 in regions opposite the corresponding main partial beams and impinge on the covering disc. Seen from the light exit side 14, each LED thus appears doubly on the base 20 of the lens body 10.

The reflected partial beams and the main partial beams are scattered by the covering disc and appear on the viewing side as diffuse light with the desired mixed colour.

In the case of the above-described lens body 10, the following modifications, inter alia, are possible:

The lens body 10 can be designed, instead of for three LEDs, also for more or fewer than three.

Instead of the red, green and blue LEDs, different kinds of lamps can be used. The lamps can also be integrated RGB lamps.

Instead of the scattering covering disc, a different kind of diffuser can also be employed.

The beam splitter surfaces 34 and the mirror surfaces 42 can also be curved instead of plane. They can also be inclined at a different angle than 45° with respect to the base 20 or the main radiating directions. The corresponding beam splitter surfaces 34 and the mirror surfaces 42 can also have different inclinations.

Instead of the mirror surfaces 42, partially reflective surfaces of a different kind of deflecting device, by which the reflected partial beam is deflected, can also be provided. In particular, the beam splitter surfaces 34 and/or the mirror surfaces 42 can also be realised via separate components instead of in the form of a single lens body 10.

The lens body 10 can be made, instead of from polycarbonate, also from a different kind of suitable light-transmitting material of optical quality, for example a different plastic or glass.

The three beam splitter surfaces 34 and the corresponding mirror surfaces 42 can be arranged, instead of at the corners of equilateral triangles, also in a different manner. The mirror surfaces 42 can also be placed in the vicinity of the beam splitter surfaces 34 assigned to them.

1. A sanitary fitting comprising at least one illuminating device, which has at least two lamps having different radiation colours for generating light with a colour additively mixed from the different radiation colours, and comprising a diffuser for the light,
wherein
at least one beam splitter for splitting the light beams into a main partial beam and a reflected partial beam is arranged between each lamp and the diffuser, and a deflecting means for deflecting the corresponding reflected partial beam is in each case provided in such a way that the reflected partial beam and the main partial beam impinge on the diffuser in different regions.

2. The sanitary fitting of claim 1, wherein the beam splitter has a partially reflective first surface, which is inclined by in particular 45° with respect to the main radiating direction of the light radiating in, and the deflecting means has in the beam path of the reflected partial beam an at least partially reflective second surface which faces the first surface, is spaced from it and has substantially the same inclination as it.

3. The sanitary fitting of claim 1, wherein in each case, a surface region, inclined with respect to the main radiating direction, of a single lens body form the beam splitter and the deflecting means respectively.

4. The sanitary fitting of claim 3, wherein the lens body is made from plastic.

5. The sanitary fitting of claim 1, wherein the centre points of three beam splitters for three lamps are arranged at the corners of an equilateral first triangle and the centre points of three deflecting means corresponding to the beam splitters are arranged in each case between two beam splitters at the corners of a similar second triangle rotated by 180° with respect to the first triangle about the latter's axis of the centre of gravity.

6. The sanitary fitting of claim 1, wherein the lamps are a red, a green and a blue LED.

7. The sanitary fitting of claim 2, wherein in each case, a surface region, inclined with respect to the main radiating direction, of a single lens body form the beam splitter and the deflecting means respectively as well.

8. The sanitary fitting of claim 2, wherein the partially reflective first surface is a plane having an incline of 45° and the partially reflective second surface is a plane.

9. The sanitary fitting of claim 2, wherein the centre points of three beam splitters for three lamps are arranged at the corners of an equilateral first triangle and the centre points of three deflecting means corresponding to the beam splitters are arranged in each case between two beam splitters at the corners of a similar second triangle rotated by 180° with respect to the first triangle about the latter's axis of the centre of gravity.

10. The sanitary fitting of claim 2, wherein the lamps are a red, a green, and a blue LED.

11. The sanitary fitting of claim 3, wherein the surface region is a plane.

12. The sanitary fitting of claim 3, wherein the centre points of three beam splitters for three lamps are arranged at the corners of an equilateral first triangle and the centre points of three deflecting means corresponding to the beam splitters are arranged in each case between two beam splitters at the corners of a similar second triangle rotated by 180° with respect to the first triangle about the latter's axis of the centre of gravity.

13. The sanitary fitting of claim 3, wherein the lamps are a red, a green, and a blue LED.

14. The sanitary fitting of claim 4, wherein the centre points of three beam splitters for three lamps are arranged at the corners of an equilateral first triangle and the centre points of three deflecting means corresponding to the beam splitters are arranged in each case between two beam splitters at the corners of a similar second triangle rotated by 180° with respect to the first triangle about the latter's axis of the centre of gravity.

15. The sanitary fitting of claim 4, wherein the lamps are a red, a green, and a blue LED.

16. The sanitary fitting of claim 5, wherein the lamps are a red, a green, and a blue LED.
